(19) United States
(12) Patent Application Publication
(10) Pub. No.: US 2013/0167399 A1
(43) Pub. Date: Jul. 4, 2013

(54) WAFER DRYING APPARATUS AND METHOD OF DRYING WAFER USING THE SAME

(71) Applicant: Yong Seok LEE, Icheon-si (KR)

(72) Inventor: Yong Seok LEE, Icheon-si (KR)

(21) Appl. No.: 13/595,895

(22) Filed: Aug. 27, 2012

(30) Foreign Application Priority Data
Dec. 30, 2011 (KR) 10-2011-0146911

(51) Int. Cl. F26B 25/06

(52) U.S. Cl. 34/443; 34/218

(57) ABSTRACT

A wafer drying apparatus and a wafer drying method using the same. A wafer is dried by a marangoni drying process using DI-CO₂ water in which CO₂ in a gas phase is added to DIW in a liquid phase, and IPA, so that a surface tension of a surface of the wafer is reduced to suppress leaning of fine patterns and watermarks.

### CROSS-REFERENCES TO RELATED APPLICATION

The present application claims priority under 35 U.S.C. 119(a) to Korean application number 10-2011-0146911, filed on Dec. 30, 2011 in the Korean Patent Office, which is incorporated by reference in its entirety.

### BACKGROUND OF THE INVENTION

1. Technical Field

The inventive concept relates to a wafer drying apparatus and a method of drying a wafer using the same, and more particularly, to a wafer drying apparatus and a method of drying a wafer using the same to prevent leaning of fine patterns formed in a surface of a wafer.

2. Related Art

Semiconductor devices that are designed for use in data storage are typically classified into volatile memory devices and nonvolatile memory devices.

The volatile memory devices represented as random access memories (DRAMs) and static random access memories (SRAMs) have fast data input/output characteristic, but may cause data stored therein to be lost in a state of power-off. Representative nonvolatile memory devices are NAND type flash memory using electrically erasable programmable read only memory (EEPROM) and NOR type flash memory using EEPROM, where they retain data stored therein even in a state of power-off.

With rapid development of information communication fields and rapid popularization of information media such as a computer, demands for next-generation semiconductor memories having ultra-high speed operation and large memory storage capacity have been gradually increased.

The next-generation semiconductor memory devices have been developed by utilizing a volatile memory device such as a DRAM and a nonvolatile memory device such as a flash memory and thus the next-generation semiconductor memory devices have advantage of low power consumption and good data retention and data read/write operation characteristics. In order to obtain the next-generation semiconductor memory devices having low power consumption and good data retention and data read/write operation characteristics, ferroelectric random access memories (FRAMs), magnetic random access memories (MRAMs), phase-change random access memories (PRAMs), or nano floating gate memories (NFGM) have been developed.

Meanwhile, when the semiconductor memory device is fabricated, a wafer cleaning process is performed to remove various kinds of particles, native oxides or pollutants such as metal impurities generated in the fabrication process.

A cleaning process performed on a wafer, for example, a wet cleaning process, includes filling aqueous chemicals adapted to remove pollutants present on a surface of the wafer with a cleaning bath and dipping the wafer into the cleaning bath, thereby removing the pollutants. After the cleaning process, moisture present on the surface of the wafer is removed by rotating the wafer at a fixed number of revolutions per minute (RPM).

However, the above-described spin drying method of removing the moisture on the surface of the wafer by rotating the wafer may not entirely remove particles from the wafer surface or may cause watermarks due to static electricity or vibration generated by high speed rotation.

In addition to the spin drying method, a marangoni drying process using a marangoni effect has been widely used. The marangoni effect denotes the principle in that liquid flows from a region where surface tension is small to a region where surface tension is large, when two or more portion having different surface tensions are present in one liquid region. The wafer drying method using the marangoni effect includes supplying isopropyl alcohol (IPA) mist having relatively smaller surface tension than deionized water (DIW) on a surface of a wafer and removing the DIW on the surface of the wafer using the marangoni effect generated due to a difference between the surface tensions of the IPA and the DIW in a process of elevating the wafer from a batch in which the DIW is filled.

This marangoni drying process using the difference between the surface tensions between the IPA and the DIW effectively reduces particles or watermarks on the surface of the wafer to be generated as compared with the spin drying method by rotating the wafer at high speed.

As integration degree of a semiconductor device is increased and corresponding design rules are reduced, dimensions of fine patterns constituting the semiconductor memory device are gradually reduced and sizes and depths of contact holes are increased so that aspect ratios thereof are more increased. Thus, when the marangoni drying process is adopted, the leaning phenomenon on which fine patterns on a surface of a wafer are collapsed occurs due to surface tension generated on the surface of the wafer. In addition, because moisture within a contract hole having a large aspect ratio is not completely removed, watermarks occur.

FIG. 1 illustrates a state of fine patterns after a marangoni drying process in the related art.

Referring to FIG. 1, after a wafer drying process is performed using a difference between DIW and IPA, fine patterns 12 formed on a surface of a wafer 10 are leaned as shown in a reference numeral “A” and adjacent patterns are in contact with each other so that failure is caused. The failure can be actually seen from FIGS. 2 and 3.

FIGS. 2 and 3 are a scanning electron microscope (SEM) photograph and a transmission electron microscope (TEM) photograph illustrating a state of patterns after a marangoni drying process in the related art.

As shown in FIGS. 2 and 3, adjacent patterns are in contact with each other due to leaning on the fine patterns formed on a surface of a wafer after a marangoni drying process in the related art.

Regardless of materials forming the fine patterns such as an insulating layer or a conductive layer, the fine patterns wrongly perform their functions due to the leaning. In particular, when the fine patterns are conductive layers, if the adjacent fine patterns are short-circuited due to the leaning, the semiconductor memory device malfunctions to be failed.

As described above, when a drying process on a wafer is performed through a marangoni drying process using DIW and IPA, it is somewhat effective to reduce occurrence of particles or watermarks on a surface of a wafer, as compared with a spin drying method. However, as the fine patterns become extremely small, the leaning phenomenon in which the fine patterns are warped or collapsed may be caused due to a marangoni effect.

### SUMMARY

According to one aspect of an exemplary embodiment, a wafer drying apparatus comprises a chamber including a cleaning unit and a drying unit; a batch disposed within the chamber, wherein a wafer arrives in the batch; a carbonated deionized (DI-CO₂) water supply nozzle unit configured to supply DI-CO₂ water into the batch, wherein carbon dioxide (CO₂) in a gas phase is dissolved in deionized water (DIW) in a liquid phase to form the DI-CO₂ water; and an isopropyl alcohol (IPA) and N2-mixed gas supply nozzle unit configured to supply a mixed gas of isopropyl alcohol (an IPA) and N2-mixed gas into the chamber.

According to another aspect of an exemplary embodiment, a wafer drying method comprises forming carbonated deionized (DI-CO₂) water by adding carbon dioxide (CO₂) in a gas phase to deionized water (DIW) in a liquid state; supplying the DI-CO₂ water into a batch through a DI-CO₂ water supply nozzle unit; injecting a wafer into the batch filled with the DI-CO₂ water; spraying a mixed solution of isopropyl alcohol (IPA) and N2 through a gas supply nozzle unit to form a mixed gas of IPA and N2 within the chamber; lifting up the wafer over the batch filled with the DI-CO₂ water using a lifter disposed within the batch; removing the DI-CO₂ water on a surface of the wafer by a difference between surface tension of a layer of the DI-CO₂ water and surface tension of a layer of the mixed gas on the surface of the wafer; and drying the surface of the wafer.

### BRIEF DESCRIPTION OF THE DRAWINGS

The above and other aspects, features and other advantages of the subject matter of the present disclosure will be more clearly understood from the following detailed description taken in conjunction with the accompanying drawings, in which:

FIG. 1 is a view illustrating a state of fine patterns after a marangoni drying process in the related art;

FIG. 2 a SEM photograph illustrating a state of fine patterns after a marangoni drying process in the related art;

FIG. 3 is a TEM photograph illustrating a state of fine patterns after a marangoni drying process in the related art;

FIG. 4 is a view illustrating a wafer drying apparatus according to an exemplary embodiment of the inventive concept; and

FIG. 5 is a view illustrating a state of fine patterns on a surface of a wafer dried by a marangoni drying process using a wafer drying apparatus according to an exemplary embodiment of the inventive concept.

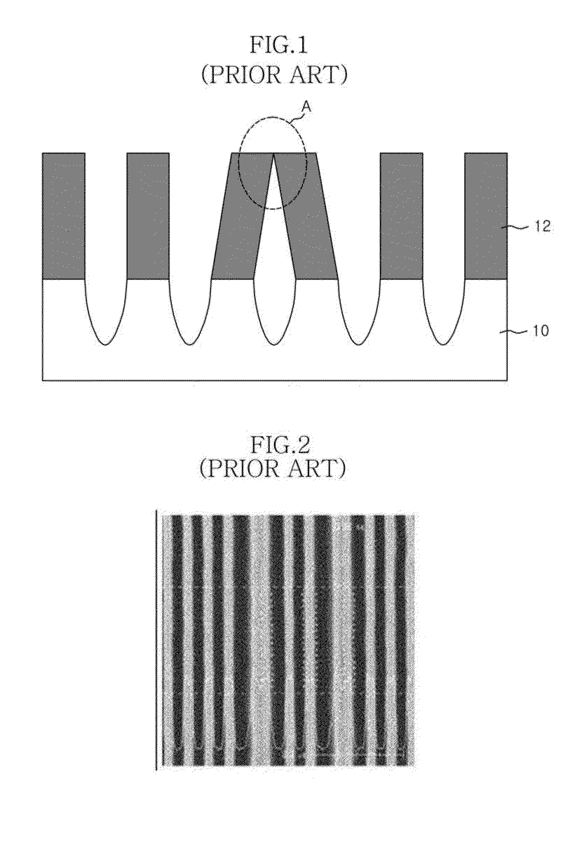

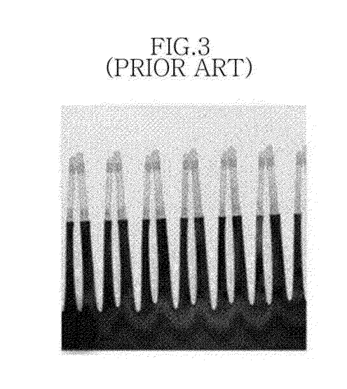

### DETAILED DESCRIPTION

Hereinafter, exemplary embodiments will be described in greater detail with reference to the accompanying drawings.

Exemplary embodiments are described herein with reference to cross-sectional illustrations that are schematic illustrations of exemplary embodiments (and intermediate structures). As such, for example, variations from the shapes of the illustrations as a result of manufacturing techniques and/or tolerances are to be expected. Thus, exemplary embodiments should not be construed as limited to the particular shapes of regions illustrated herein but may be to include, for example, deviations in shapes that result from manufacturing. In the drawings, lengths and sizes of layers and regions may be exaggerated for clarity. Like reference numerals in the drawings denote like elements. It is also understood that when a layer is referred to as being “on” another layer or substrate, it can be directly on another layer or substrate, or intervening layers may also be present.

Hereinafter, a semiconductor memory device and a method of manufacturing the same according to an exemplary embodiment of the inventive concept will be described with reference to the following drawings in detail.

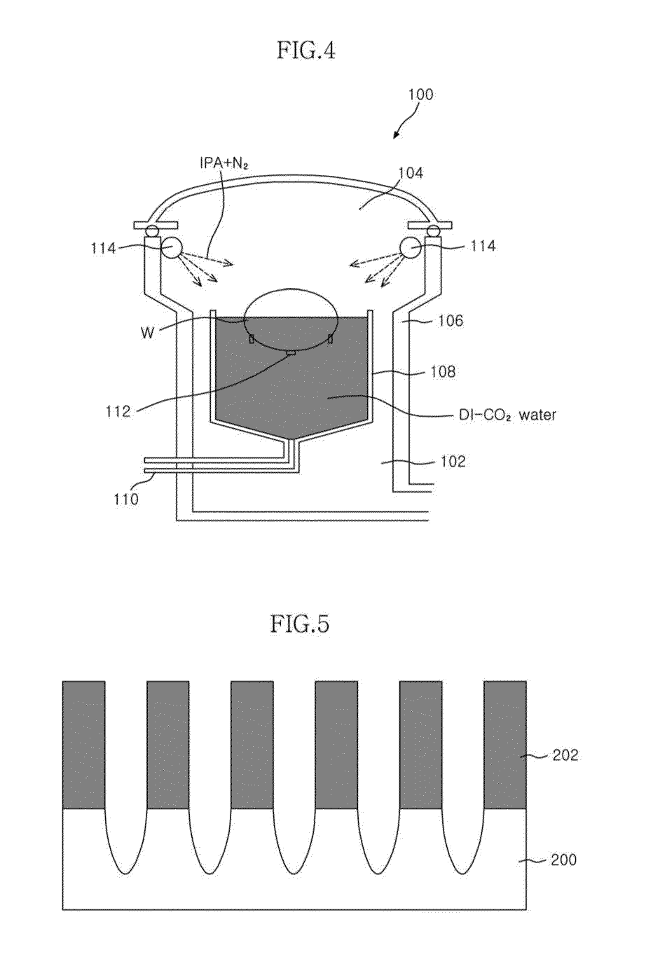

FIG. 4 illustrates a wafer drying apparatus 100 according to an exemplary embodiment of the inventive concept.

Referring to FIG. 4, the wafer drying apparatus 100 according to an exemplary embodiment includes a chamber 106 including a cleaning unit 102 and a drying unit 104, a batch 108 which is disposed inside the cleaning unit 102 of the chamber 106 and in which a wafer W is dipped, a DI-CO₂ water supply nozzle unit 110 configured to supply DI-CO₂ water into the batch, a lifter 112 configured to lift up the wafer W which safely arrived inside the batch 108, an IPA and N₂-mixed gas supply nozzle unit 114 configured to supply an IPA and N₂-mixed gas into the chamber 106.

Here, the DI-CO₂ water supply nozzle unit 100 serves as a passage configured to supply the DI-CO₂ water into the batch 108 and drain the DI-CO₂ water filled in the batch 108 and may include at least one nozzle unit. The IPA and N₂-mixed gas supply nozzle unit 114 may include at least one nozzle unit if necessary.

In the exemplary embodiment, a drying process on the wafer is performed by using the DI-CO₂ water filled inside the batch 108 and the IPA and N₂-mixed gas supplied into the chamber 106 through the IPA and N₂-mixed gas supply nozzle unit 114. The drying process will be described in detail below.

First, CO₂ in a gas phase is added to DIW in a liquid phase to form DI-CO₂ water and then the DI-CO₂ water is supplied into the batch 108 through the DI-CO₂ water supply nozzle unit 110. At this time, the Di-CO₂ water of about 40 liters is filled within the batch 108. The DI-CO₂ water may be formed by adding CO₂ of 10 to 100 ppm per DIW of 1 liter to the DIW. A temperature of the DI-CO₂ water may be maintained in a range of 25 to 30° C.

An atmosphere with a high pressure and a low temperature may be created to add the CO₂ in a gas phase to the DIW in a liquid phase. Therefore, the DI-CO₂ water may be formed by filling the DIW the batch 108 and then adding the CO₂ in a gas phase to the DIW through a separate nozzle. However, the process of forming the DI-CO₂ water may be complicated. Accordingly, as in the exemplary embodiment, the DI-CO₂ water may be previously formed in the outside of the chamber 106 and then supplied into the batch 108 through the DI-CO₂ water supply nozzle unit 110.

Subsequently, the wafer W is injected into the batch 108 filled with the DI-CO₂ water, and an IPA and N₂-mixed solution is sprayed through the IPA and N₂-mixed gas supply nozzle unit 114 so that the inside of the chamber 106 becomes in an IPA and N₂-mixed gas atmosphere. Because the IPA and N₂-mixed gas supply nozzle unit 114 is disposed in an upper end portion of the chamber 106, the IPA and N₂-mixed gas atmosphere is formed in an upper end portion of the batch 108, that is, an upper region of the chamber 106.

Then, the wafer W is lifted up from the batch 108 filled with the DI-CO₂ water.

As a result, the wafer W dipped in the DI-CO₂ water is met with the IPA and N₂-mixed gas and the DI-CO₂ water on a surface of the wafer W is removed by a difference between surface tension of a layer of the DI-CO₂ water and surface tension of a layer of the IPA and N₂-mixed gas, that is, a marangoni force, so that the surface of the wafer is dried. At this time, a dry time in which the wafer W is lifted up from the batch 108 and the DI-CO₂ water on the surface of the wafer is removed may be maintained within a range of 300 to 600 seconds.

FIG. 5 illustrates a state of fine patterns on a surface of a wafer dried by a marangoni drying process using the wafer drying apparatus of FIG. 5.

Referring to FIG. 5, when a wafer 200 is dried using the wafer drying apparatus shown in FIG. 4, leaning is not caused in fine patterns 202 formed on a surface of the wafer 200.

In the related art, because a wafer is dried using, for example, only DIW, leaning is caused in fine patterns formed on a surface of the wafer. However, in the exemplary embodiment of the inventive concept, a wafer is dried using DI-CO₂ water in which CO₂ is added to DIW so that leaning of fine patterns is suppressed by reducing surface tension of the wafer as compared with the wafer drying method using only DIW in the related art.

In addition, the DI-CO₂ water having smaller surface tension than DIW penetrates inside a deep contact hole having a large aspect ratio so that a better dry effect even in the deep contact hole can be obtained. As a result, electrical characteristics of the semiconductor memory device can be improved and total yield can be more improved.

While certain embodiments have been described above, it will be understood that the embodiments described are by way of example only. Accordingly, the devices and methods described herein should not be limited based on the described embodiments. Rather, the systems and methods described herein should only be limited in light of the claims that follow when taken in conjunction with the above description and accompanying drawings.

What is claimed is:

1. A wafer drying apparatus, comprising:
a chamber including a cleaning unit and a drying unit;
a batch disposed within the chamber, wherein a wafer arrives in the batch;
a carbonated deionized (DI-CO₂) water supply nozzle unit configured to supply DI-CO₂ water into the batch, wherein carbon dioxide (CO₂) in a gas phase is dissolved in deionized water (DIW) in a liquid phase to form the DI-CO₂ water; and
a gas supply nozzle unit configured to supply a mixed gas of isopropyl alcohol (IPA) and N₂ into the chamber.

2. The wafer drying apparatus of claim 1, wherein each of the DI-CO₂ water supply nozzle unit and the mixed gas supply nozzle unit includes at least one nozzle unit disposed inside the chamber.

3. The wafer drying apparatus of claim 2, further including a lifter disposed inside the batch so as to lift up the wafer.

4. A wafer drying method, comprising:
forming carbonated deionized (DI-CO₂) water by adding carbon dioxide (CO₂) in a gas phase to deionized water (DIW) in a liquid state;
supplying the DI-CO₂ water into a batch through a DI-CO₂ water supply nozzle unit;
injecting a wafer into the batch filled with the DI-CO₂ water;
spraying a mixed solution of isopropyl alcohol (IPA) and N₂ through a gas supply nozzle unit to form a mixed gas of IPA and N₂ within the chamber;
lifting up the wafer over the batch filled with the DI-CO₂ water using a lifter disposed within the batch;
removing the DI-CO₂ water on a surface of the wafer by a difference between surface tension of a layer of the DI-CO₂ water and surface tension of a layer of the mixed gas on the surface of the wafer; and
drying the surface of the wafer.

5. The method of claim 4, wherein the forming the DI-CO₂ water includes adding the CO₂ gas of 10 to 100 ppm per DIW of 1 liter to the DIW.

6. The method of claim 5, wherein a temperature of the DI-CO₂ water is maintained in a range of 25 to 30° C.

7. The method of claim 6, wherein a dry time during which the wafer is lifted up from the batch and the DI-CO₂ water is removed from the surface of the wafer is maintained to be in a range of 300 to 600 seconds.
